(19) United States
(12) Patent Application Publication
(10) Pub. No.: US 2007/0009076 A1
(43) Pub. Date: Jan. 11, 2007

(54) Device for recovering waste materials from a confined space

(76) Inventors: Kevin Hunt, Arlington, Bibury, Gloucestershire (GB); Jeffrey Collins, Tewkesbury (GB)

Correspondence Address: MOORE & VAN ALLEN PLLC, P.O. BOX 13706, Research Triangle Park, NC, 27709, US

(21) Appl. No.: 10/562,209

(22) PCT Filed: Jun. 23, 2004
(86) PCT No.: PCT/GB04/02698

§ 371 Date: Apr. 27, 2006

(30) Foreign Application Priority Data
Jun. 25, 2003 (GB) 0314819.4

(51) Int. Cl. G21C 19/32

(52) U.S. Cl. 376/260

(57) ABSTRACT

The invention provides a recovery device and method for use in a confined space, the device comprising (a) a plurality of gripping means and (b) extension means, the plurality of gripping means being comprised in the same member or in adjacent members. Preferably, the plurality of gripping means comprise first gripping means and second gripping means and the recovery device additionally comprises collection means for the loose and particulate debris collected by the second gripping means. The invention provides a solution to the problem of repeated access to confined spaces such as mortuary tubes by providing a recovery device capable of handling a mixture of drums and loose waste without necessitating the changing of tools.

### FIELD OF THE INVENTION

The present invention relates to the recovery of waste materials, and provides an apparatus and method which allow for the more efficient retrieval of waste materials in confined spaces. Specifically, the invention provides a means of handling mixed waste forms and drummed waste using a single tool. The invention finds particular application in the handling of radioactive waste materials within the confines of waste mortuary tubes, and offers significant gains in the production rate of such retrieval operations.

### BACKGROUND TO THE INVENTION

The waste retrieval machines of the prior art suffer from operational problems when being required to recover mixed waste from within the very tight confines of mortuary tubes whilst working to severe programme constraints. The waste route from these tubes is typically from a point at the top of the tubes, via transfer drums. When the base waste is in the form of drums stacked one on top of another, there is evidence that many of the drums become damaged, or degenerate, so that the waste is caused to spill out of them or is otherwise no longer satisfactorily contained in them. In addition, numerous long steel drum-handling wires are released into the tubes and these become entangled with the drums and waste.

Whilst waste in drums can be transferred effectively by a single grabbing operation, conventional recovery methods require repeated excursions into the mortuary tubes to recover what may be minute amounts of debris at a time. Furthermore, the drums are handled by one type of tool while loose waste has to be recovered using a completely different device, with the consequence that repeated tool changing is necessary. The problem is exacerbated in the context of radioactive waste, since the potential mixture of drum-handling wires and loose debris may even contain fragments of fissile material.

The invention seeks to address the problem of repeated access to confined spaces such as mortuary tubes by providing a recovery device capable of handling a mixture of drums and loose waste without necessitating the changing of tools.

### SUMMARY OF THE INVENTION

Thus according to a first aspect of the present invention, there is provided a recovery device for use in a confined space, said device comprising (a) a plurality of gripping means and (b) extension means, said plurality of gripping means being comprised in the same member or in adjacent members. Preferably, said plurality of gripping means comprise first gripping means and second gripping means.

It is the function of said first gripping means to engage with, and facilitate recovery of a container, such as a drum. Preferably, therefore, said first gripping means comprises a cylindrical device or other device, typically in the form of a sleeve which can encompass such a container, and said device includes engaging means which facilitate engagement with the said container. Typically said engaging means may be in the form of elongated members incorporating pivoting means, for example long blades which include pivot points for a plurality of fingers which can engage with a drum.

Said second gripping means serves to remove loose and particulate debris present within the confined space. Consequently, said second gripping means preferably comprises a movably mounted flexible arm incorporating gripping means, preferably in the form of a grab or gripper. Said second gripping means is preferably rotatably mounted, and may either be mounted within said first gripping means or adjacent said first gripping means. In a preferred arrangement, said second gripping means comprises a flexible arm mounted inside a sleeve comprised in said first gripping means.

Preferably, said recovery device additionally comprises collection means for the loose and particulate debris collected by said second gripping means. Most preferably, said collection means comprises a container such as a pouch. Said container is most conveniently removably mounted on said first gripping means, and a favoured arrangement comprises a removable pouch mounted inside a sleeve which is comprised in said first gripping means. In a particularly preferred embodiment of the present invention, said collection means additionally comprises containment means designed to ensure that collected debris cannot fall out of said collection means. Typically, said containment means may comprise, for example, a spring-loaded closure.

Said extension means comprises means by which the first and second gripping means may be manoeuvred within the confined space. Typically, said extension means may comprise, for example, a winch mechanism, an umbilical device or, more preferably, a telescopic mast, which offers the best means of supplying lateral and torsional resistance to rotation of the first gripping means.

According to a second aspect of the present invention, there is provided a method for the recovery of waste materials, said method comprising the recovery of said materials by the use of a recovery device according to the first aspect of the invention.

The use of the device hereinbefore defined facilitates the recovery of defined objects, such as containers, together with debris that has emanated from the degradation of those defined objects without recourse to lengthy outages for tool changing operations, or the repeated entry and withdrawal of waste from the confined spaces, such as mortuary tubes.

### DETAILED DESCRIPTION OF THE INVENTION

The device according to the invention is thus adapted to recover waste from confined spaces, and it incorporates two distinct mechanisms that work independently or in concert to enable the simultaneous or independent recovery of waste in its prime form in cans and drums or in its degenerate form as loose debris. The action of the device is achieved by mounting one recovery device above and/or within another. Typically, this requires the placement of a small, limited degree of freedom manipulator arm located within a cylindrical sleeve and the placement of removable debris pouches attached to the inside walls of the outer sleeve in which loose debris may be collected. The device may also include the additional means, located axial to the sleeve, whose function is to prise jammed debris from the walls of the confined space and centralise it within the recovery device.

A particularly favoured embodiment of the first aspect of the present invention comprises a multi-function recovery device which comprises a winch, umbilical or a telescopic mast attached to a tubular element comprising an outer sleeve having sides which incorporate long windows. At its lower end, the outer sleeve is fitted with long blades and pivot points for a number of fingers, preferably 3 fingers. The blades are slim enough to fit down the narrow gap that exists between the outside of a drum and the inside of a mortuary tube. When the sleeve is rotated, it causes the drum to be prised the drum away from the tube walls and allows the drum to be released should it become jammed in the tube by impact of other debris falling on it. The fingers may be individually actuated in order that a drum may be gripped around its rim, thereby facilitating its recovery.

There is a high likelihood that debris will be resting on the top of the drum and thereby preventing immediate recovery of the drum. This loose debris may be in the form of, for example, the drum-handling wire, or other loose material that has been left by a damaged or corroded drum. The removal of this debris is necessary and is achieved by the action of the second gripping means, comprising a manipulator arm. The debris is thus removed and placed in removable pouches that are attached to the inside of the outer sleeve.

The manipulator arm serves to clear loose debris from the mortuary tube, in particular from the top of a drum, and thereafter to put it into the debris pouches without withdrawing the multi-function recovery device from the mortuary tube. The waste pouches are preferably equipped with spring-loaded tops that prevent debris, such as wire, from slipping back into the mortuary tube.

The manipulator arm has low ‘diametral profile’, and its principal degree of freedom is its ability to travel parallel to, but relative to, the outer sleeve and beyond the end thereof. In addition, the arm is capable of flexing laterally and rotating about its own axis, such that it is able to extend downward to recover waste from the tube and then retract to place the debris in the pouches. The end of the manipulator comprises an effector, which can be changed to in order to suit the particular application for which it is intended. Preferably the effector is either a grab or gripper. Optionally, the effector may also deploy a small wire cutter.

The fingers for gripping the drum are preferably of such a size and configuration that they can grip a pintle adaptor screwed into the top of a shield plug associated with a drum used in the containment of radioactive waste. In operation, the shield plug is removed by the recovery device, which is then used to remove drums that are intact. Where drum-handling wires are discovered, they are cut free or cut to length by using the manipulator to pull them through the jaws of a hydraulically-operated shear and pushing the end into one of the recovery pouches. The recovery pouch will incorporate a spring-loaded flap that functions as a ‘one-way’ valve for the wire being pushed into the pouch. Other debris is also collected and put into the pouches.

When the pouches are full, the recovery device withdraws the gripping means from the mortuary tube as if it was returning with a drum and the transfer container is moved under the device. The manipulator arm then lifts the pouches from their support hooks on the inside of the outer sleeve and lowers them into the transfer container. Replacement pouches can be stored inside the recovery device and can be lifted into their working positions by the manipulator. The recovery device can then return to the mortuary tube and continue operations as before. Thus, operation of the recovery device is maintained on a continuous basis, and waste recovery is reliable and efficient.

1. A recovery device for use in a confined space, said device comprising (a) a plurality of gripping means and (b) extension means, said plurality of gripping means being comprised in the same member or in adjacent members.

2. A recovery device as claimed in claim 1 wherein said plurality of gripping means comprise first gripping means and second gripping means.

3. A recovery device as claimed in claim 2 wherein said first gripping means comprises a cylindrical device.

4. A recovery device as claimed in claim 3 wherein said cylindrical device is in the form of a sleeve adapted to encompass and engage with a container.

5. A recovery device as claimed in claim 1 which comprises engaging means.

6. A recovery device as claimed in claim 5 wherein said engaging means comprises elongated members incorporating pivoting means.

7. A recovery device as claimed in claim 6 wherein said elongated members incorporating pivoting means comprise long blades which include pivot points for a plurality of fingers which can engage with a container.

8. A recovery device as claimed in claim 2 wherein said second gripping means comprises a movably mounted flexible arm incorporating said gripping means.

9. A recovery device as claimed in claim 8 wherein said second gripping means comprises a movably mounted flexible arm incorporating gripping means in the form of a grab or gripper.

10. A recovery device as claimed in claim 2 wherein said second gripping means is rotatably mounted.

11. A recovery device as claimed in claim 10 wherein said second gripping means is rotatably mounted within said first gripping means or adjacent said first gripping means.

12. A recovery device as claimed in claim 2 wherein said second gripping means comprises a flexible arm mounted inside a sleeve comprised in said first gripping means.

13. A recovery device as claimed in claim 2 wherein said second gripping means comprises a manipulator arm.

14. A recovery device as claimed in claim 13 wherein the end of said manipulator arm comprises an effector.

15. A recovery device as claimed in claim 14 wherein said effector comprises a grab or gripper.

16. A recovery device as claimed in claim 14 or 15 wherein said effector additionally comprises a small wire cutter.

17. A recovery device as claimed in any preceding claim 1 which additionally comprises collection means for loose and particulate debris collected by said second gripping means.

18. A recovery device as claimed in claim 17 wherein said collection means comprises a container.

19. A recovery device as claimed in claim 18 wherein said container is removably mounted on said first gripping means.

20. A recovery device as claimed in claim 19 wherein said container comprises a removable pouch mounted inside a sleeve which is comprised in said first gripping means.

21. A recovery device as claimed in claim 17 wherein said collection means additionally comprises containment means designed to ensure that collected debris cannot fall out of said collection means.

22. A recovery device as claimed in claim 21 wherein said containment means includes a spring-loaded closure.

23. A recovery device as claimed in claim 1 wherein said extension means comprises means by which the first and second gripping means may be manoeuvred within a confined space.

24. A recovery device as claimed in claim 1 wherein said extension means comprises a winch mechanism, an umbilical device or a telescopic mast.

25. A recovery device as claimed in claim 1 which comprises a small, limited degree of freedom manipulator arm located within a cylindrical sleeve and removable debris pouches attached to the inside walls of the sleeve in which loose debris may be collected.

26. A recovery device as claimed in claim 1 which comprises a tubular element comprising an outer sleeve having sides which incorporate long windows, said outer sleeve being fitted at its lower end with long blades and pivot points for a plurality of fingers, said blades being of such dimensions as to fit down the gap between the outside of a drum and the inside of a mortuary tube.

27. A method for the recovery of waste materials, said method comprising the recovery of said materials by the use of a recovery device according to claim 1.
